(19) United States
(12) Patent Application Publication
(10) Pub. No.: US 2018/0322561 A1
(43) Pub. Date: Nov. 8, 2018

(54) METHOD AND SYSTEM FOR AUTOMATED FULFILLMENT VIA BLOCKCHAIN

(71) Applicant: Mastercard International Incorporated, Purchase, NY (US)

(72) Inventor: Ankur ARORA, Jasola (IN)

(73) Assignee: Mastercard International Incorporated, Purchase, NY (US)

(21) Appl. No.: 15/586,408

(22) Filed: May 4, 2017

(51) Int. Cl. G06Q 30/06; G06F 17/30; G06Q 30/08

(52) U.S. Cl. CPC G06Q 30/0633; G06Q 30/08; G06F 17/30477

(57) ABSTRACT

A method for automated product fulfillment via blockchain includes: storing product profiles, each including a product identifier, storage amount, and threshold level; receiving product updates for products including a specific product identifier and a current product level; updating a specific product profile for each product update by updating the storage amount based on the current product level using the specific product identifier; identifying product profiles where the updated storage amount is less than the threshold level; generating a transaction value for each identified product profile, wherein the transaction value includes a unique identifier associated with the computing device and the product identifier included in the respective product profile; and transmitting each generated transaction value to a node in a blockchain network.

### FIELD

The present disclosure relates to automated fulfillment of products via the use of a blockchain, specifically the ability for a computing device to identify when a product needs to be fulfilled and request such fulfillment via a blockchain accessible by multiple vendors, which are able to bid on fulfillment of such products through the computing device.

### BACKGROUND

As technology has improved, it has often been used to provide greater convenience to consumers. The rise of the Internet led to online ordering of food and other products, while the creation of powerful mobile computing devices led to application programs that enabled consumers to find and order products even faster. In more recent years, household electronics and appliances have been integrated with computing devices, often referred to as “smart” appliances, to provide additional conveniences to consumers. For example, smart refrigerators have been developed that can monitor the products inside of the refrigerator to determine when replacements should be ordered, such as by identifying when a carton of milk is almost empty and notifying the consumer. In some cases, the refrigerator may even be connected to the Internet, either directly or via another device, and enable the consumer to purchase a replacement product (e.g., another carton of milk) for delivery.

However, such systems often still face a number of disadvantages. For instance, existing fulfillment systems are not anonymous, which enables vendors to track the habits and practices of a consumer, which may be uncomfortable for some consumers and may result in differential billing, e.g., items may be priced to yield greater margins by tracking individuals purchasing habits. In addition, existing systems are often limited in terms of vendors that are available for fulfillment of a product. In some cases, the manufacturer of the device may partner with one or more vendors, limiting purchase to this small set of choices. In other cases, the manufacturer may provide a list of vendors or a web browser to enable the consumer to select a vendor. However, such cases still limit the consumer's ability to find all available vendors, and may make it exceedingly difficult for an unknown vendor to be matched with the consumer, even if the unknown vendor may be the most ideal for the consumer (e.g., in terms of price, delivery, etc.).

Thus, there is a need for a technological solution for the automated fulfillment of products that can provide for user anonymity and the ability for unknown vendors to be matched with product fulfillment to better meet consumer criterion and increase the viability of vendors for fulfillment.

### SUMMARY

The present disclosure provides a description of systems and methods for automated product fulfillment via blockchain. A computing device can identify a product level that goes below a specified threshold, such that fulfillment is automatically requested when that occurs. The product details are posted to a blockchain such that the details regarding the consumer are anonymous, providing for greater consumer security. In addition, the accessibility of blockchains can enable a wide variety of vendors, anyone that can access the blockchain, to bid on fulfillment of the product, enabling consumers to be matched with the best possible vendor for their situation, and providing vendors with a greater ability to reach consumers without the need to partner directly with device manufacturers or advertise. As a result, merchants and consumers can be efficiently paired with minimal effort by both parties.

A method for automated product fulfillment via blockchain includes: storing, in a product database of a computing device, a plurality of product profiles, wherein each product profile includes a structured data set related to a product including at least a product identifier, a storage amount, and a threshold level; receiving, by an input device interfaced with the computing device, product updates for one or more products, wherein each product update includes at least a specific product identifier corresponding to the respective product and a current product level; executing, by a querying module of the computing device, at least one query on the product database to update a specific product profile for each product update by updating the storage amount included in the product profile based on the current product level included in the respective product update, where the product identifier included in the specific product profile corresponds to the specific product identifier included in the respective product update; executing, by the querying module of the computing device, a query on the product database to identify one or more product profiles where the updated storage amount is less than the threshold level included in the respective product profile; generating, by a generation module of the computing device, a transaction value for each of the identified one or more product profiles, wherein the transaction value includes at least a unique identifier associated with the computing device and the product identifier included in the respective product profile; and electronically transmitting, by a transmitting device of the computing device, each generated transaction value to a node in a blockchain network.

A system for automated product fulfillment via blockchain includes: a product database of a computing device configured to store a plurality of product profiles, wherein each product profile includes a structured data set related to a product including at least a product identifier, a storage amount, and a threshold level; an input device interfaced with the computing device configured to receive product updates for one or more products, wherein each product update includes at least a specific product identifier corresponding to the respective product and a current product level; a querying module of the computing device configured to execute at least one query on the product database to update a specific product profile for each product update by updating the storage amount included in the product profile based on the current product level included in the respective product update, where the product identifier included in the specific product profile corresponds to the specific product identifier included in the respective product update, and a query on the product database to identify one or more product profiles where the updated storage amount is less than the threshold level included in the respective product profile; a generation module of the computing device configured to generate a transaction value for each of the identified one or more product profiles, wherein the transaction value includes at least a unique identifier associated with the computing device and the product identifier included in the respective product profile; and a transmitting device of the computing device configured to electronically transmit each generated transaction value to a node in a blockchain network.

### BRIEF DESCRIPTION OF THE DRAWING FIGURES

The scope of the present disclosure is best understood from the following detailed description of exemplary embodiments when read in conjunction with the accompanying drawings. Included in the drawings are the following figures:

FIG. 1 is a block diagram illustrating a high level system architecture for automated fulfillment via blockchain in accordance with exemplary embodiments.

FIG. 2 is a block diagram illustrating the computing device of the system of FIG. 1 for processing automatic fulfillment of products using a blockchain in accordance with exemplary embodiments.

FIG. 3 is a flow diagram illustrating a process for automated product fulfillment using a blockchain in the system of FIG. 1 in accordance with exemplary embodiments.

FIG. 4 is a flow chart illustrating an exemplary method for automated fulfillment via blockchain in accordance with exemplary embodiments.

FIG. 5 is a block diagram illustrating a computer system architecture in accordance with exemplary embodiments.

Further areas of applicability of the present disclosure will become apparent from the detailed description provided hereinafter. It should be understood that the detailed description of exemplary embodiments are intended for illustration purposes only and are, therefore, not intended to necessarily limit the scope of the disclosure.

### DETAILED DESCRIPTION

### Glossary of Terms

Blockchain—A public ledger of all transactions of a blockchain-based currency. One or more computing devices may comprise a blockchain network, which may be configured to process and record transactions as part of a block in the blockchain. Once a block is completed, the block is added to the blockchain and the transaction record thereby updated. In many instances, the blockchain may be a ledger of transactions in chronological order, or may be presented in any other order that may be suitable for use by the blockchain network. In some configurations, transactions recorded in the blockchain may include a destination address and a currency amount, such that the blockchain records how much currency is attributable to a specific address. In some instances, the transactions are financial and others not financial, or might include additional or different information, such as a source address, timestamp, etc. In some embodiments, a blockchain may also or alternatively include nearly any type of data as a form of transaction that is or needs to be placed in a distributed database that maintains a continuously growing list of data records hardened against tampering and revision, even by its operators, and may be confirmed and validated by the blockchain network through proof of work and/or any other suitable verification techniques associated therewith. In some cases, data regarding a given transaction may further include additional data that is not directly part of the transaction appended to transaction data. In some instances, the inclusion of such data in a blockchain may constitute a transaction. In such instances, a blockchain may not be directly associated with a specific digital, virtual, fiat, or other type of currency.

### System for Automated Product Fulfillment via Blockchain

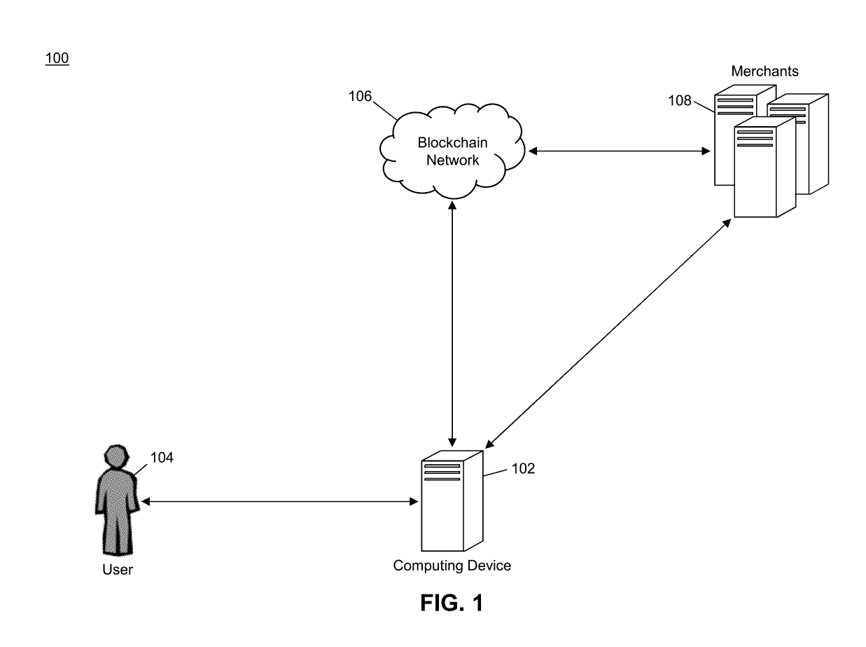

FIG. 1 illustrates a system 100 for the automated fulfillment of products using a blockchain based on product level and user criteria.

The system 100 may include a computing device 102. The computing device 102, discussed in more detail below, may be a specially configured device that is configured to identify product levels and initiate automated fulfillment thereof via a blockchain. In some cases, the computing device 102 may be part of a greater device that is used to house products or otherwise detect product levels for use by the computing device 102. For instance, the computing device 102 may comprise or be part of a smart appliance, such as a smart refrigerator configured to store refrigerated products and detect levels of products stored therein. In another example, the computing device 102 may comprise or be part of a storage box in a pantry that is used to store a specific product, such as cat food, paper towels, soft drinks, or any other product that may be fulfilled. Accordingly, the computing device 102 may comprise or be integrated with any device that may house or otherwise be able to identify a level for an associated product.

The computing device 102 may identify the level of one or more products using any suitable method. In some cases, the identification method may be dependent on the product being measured, as well as the method of storage of the product. For instance, a level of a product may be based on weight measured via a scale or other method, based on physical area taken by the product measured via scales, motion detection, optical imaging, etc., or other suitable detection method. The computing device 102 may also be configured to identify each product for which a level is identified. In some cases, the computing device 102 may be configured to read a product identifier, such as emitted by or displayed on the product. For example, the product may have a machine-readable code (e.g., a bar code, quick response code, etc.) displayed thereon read by an optical imaging device. In another example, the product may electronically transmit an identifier via near field communication or other suitable communication method. In some instances, the product identifier may be registered with the computing device 102. For instance, the computing device 102 may have a number of drawers to hold products, where the product identifier for the product stored in each drawer is registered with the computing device 102 using a suitable interface.

In the system 100, a user 104 may utilize input and display devices of the computing device 102 to interact therewith. Among other features, the computing device 102 may be configured to enable the user 104 to set threshold levels for products associated therewith. A threshold level may be set by the user 104 such that when a level of the associated product goes below that threshold level, the computing device 102 may initiate automated fulfillment of that product. For instance, the user 104 may specify a specific amount of remaining milk (e.g., by weight, volume in carton, number of cartons, etc.) before automated fulfillment is to be initiated. The computing device 102 may store such data in memory located therein, and may compare identified levels of products with their associated threshold levels.

When the computing device 102 detects that the current level for a product is below the threshold level registered for that product, the computing device 102 may initiate automated fulfillment thereof. The computing device 102 may identify the product identifier for the product for posting to a blockchain. The blockchain may be a distributed ledger that is used to store a plurality of transaction data values, where each transaction data value may correspond to a request for fulfillment or an indication of fulfillment thereof.

A blockchain may be comprised of a plurality of blocks, where each block is comprised of a block header and one or more transaction data values. A block header may be comprised of at least a timestamp, a reference value, and a transaction value. The timestamp may be the time at which the associated block was generated and/or added to the blockchain. The reference value may be a reference to an earlier block in the blockchain, typically the most recently added block prior to that respective block (e.g., as determined via timestamp). In some embodiments, the reference value may be a hash value generated via the hashing of the block header stored in the earlier block. The transaction value may be a reference to the transaction data entry or entries stored in the same block. In some embodiments, the transaction value may be generated via the hashing of the transaction data entry or entries, and, in some cases, may be the root of a Merkle tree generated using the transaction data entries. The use of the reference value and transaction value may ensure that the data in the blockchain is not modified, as the modification of even a single transaction value would be revealed via the transaction value in the corresponding block and the reference value in every subsequent block, thus ensuring that the blockchain is an immutable record.

The blockchain may be associated with a blockchain network 106. The blockchain network 106 may be comprised of a plurality of nodes, which may be computing devices specifically configured to generate and verify blocks for addition to the associated blockchain. In some embodiments, the computing device 102 may be a node in the blockchain network 106. In other embodiments, the computing device 102 may generate a transaction value for the product fulfillment, which may be electronically transmitted to a node in the blockchain network 106 using a suitable method. The transaction value for a product fulfillment may include at least the product identifier for the product to be fulfilled and a device identifier associated with the computing device 102. In some cases, a transaction value may include additional data, such as criteria for use in fulfillment of the product, as discussed in more detail below.

The blockchain node (e.g., the computing device 102, if applicable) may receive the transaction value for the product fulfillment and include it in a plurality of transaction values being added in a new block in the blockchain. The blockchain node may generate the block header for the new block (e.g., including the reference value that is based on, in part, the transaction value for the product fulfillment) and then the new block that includes the block header and plurality of transaction values. The block may be validated by other nodes in the blockchain network 106 using suitable methods for validation thereof, and then may be added to the blockchain and distributed to each node in the blockchain network 106.

A plurality of merchants 108 may access the blockchain from the blockchain network 106 and review the new transaction values stored in newly added blocks, including the transaction value generated by the computing device 102 for fulfillment of the product. A merchant 108 may have a desire to fulfill the product and may, as a result, submit a bid for fulfillment of the product to the computing device 102. In some embodiments, the merchant 108 may submit the bid directly to the computing device 102, such as by using the device identifier included in the transaction value. In other embodiments, the merchant 108 may submit the bid to the blockchain network 106, which may forward the bid to the computing device 102.

The computing device 102 may receive bids from one or more merchants 108 for fulfillment of the product, and may identify a winning bid therefrom. If a winning bid is identified, the computing device 102 may contact the merchant 108 (e.g., either directly or via the blockchain network 106) to inform the merchant 108 that they won and provide any additional details for fulfillment (e.g., a shipping address, billing information, etc.). The merchant 108 may then proceed to fulfill the product using standard processes.

In some embodiments, the computing device 102 may be configured to enable the user 104 to set criteria regarding fulfillment of a product, in addition to the product's threshold level. For instance, the user 104 may set a fulfillment amount (e.g., how much of the product should be ordered via the fulfillment) and other product preferences, such as specifying size, brand, quantity, type, etc., for a product. For example, the user 104 may specify that they want whole milk and want the cheapest product with no preference as to brand, but as for cat food want a specific brand, set of flavors, size, and quantity. In such cases, criteria for fulfillment may be included in the transaction value that is added to the blockchain, such that merchants 108 reviewing the transaction value are aware of the correct product to supply such that it complies with the criterion set forth by the user 104. The use of the blockchain to convey such criteria may be beneficial for the user 104 and merchants 108 if a product fulfillment is disputed, as the blockchain serves as an immutable record regarding the product fulfillment. Thus, a user 104 cannot unfairly challenge a correct fulfillment and a merchant 108 can be found at fault if sending a product that was not specifically requested by the user 104. As a result, the use of the blockchain to include criteria for product fulfillment may further increase the benefits provided to users 104 and merchants 108.

In addition to criteria regarding product fulfillment, the computing device 102 may also be configured to enable the user 104 to provide criteria regarding general fulfillment of products. For example, the user 104 may register shipping information, billing information, product or merchant preferences, pricing preferences, and other criteria that may be used by the computing device 102 generally in the automated fulfillment of products. For instance, the user 104 may register a product-wide policy of always requesting that the lowest merchant bid wins, absent product-specific criteria to the contrary, and have a preferred payment method (e.g., if accepted by the winning merchant 108, with a backup provided) and shipping method (e.g., always overnight shipping, overnight shipping below a certain price threshold, shipping methods specified by product category, etc.). Such criteria may be stored in the computing device 102 and used thereby when identifying winning bids and when communicating with a winning merchant 108 regarding product fulfillment.

In some embodiments, the computing device 102 may be configured to update the blockchain when a winning bid is identified. In such embodiments, the computing device 102 may generate a new transaction value for the product fulfillment that includes an indication that a product has been fulfilled or otherwise indicating that the fulfillment is closed. The new transaction value may be added to the blockchain, which may indicate to any merchants 108 that the corresponding product fulfillment is closed. For instance, a merchant 108 may identify the original transaction value indicating that fulfillment for a product is requested, and may then examine any subsequent blocks to identify if there are any transaction values having the same device identifier and product identifier that indicate that the fulfillment is closed. If no such transaction value is found, the merchant 108 can determine that bidding is still open and submit a bid to the computing device 102.

The methods and systems discussed herein enable a user 104 to have products fulfilled automatically and via the use of a blockchain. The blockchain provides for an immutable and widely accessible record, to ensure that a wide variety of merchants 108 are able to fulfill the user's needs to provide the user 104 with greater selection of merchants 108 and more customized fulfillment, and provide more merchants 108 with the ability to supply consumers. In addition, the use of the blockchain can provide for additional protection for both users 104 and merchants 108 regarding any problems related to fulfillment, while also enabling merchants 108 to fulfill product needs of consumers without having to provide a web site, application program, or other interface to the user 104. As a result, more users 104 and more merchants 108 can have faster, easier, and more targeted fulfillment of products.

### Computing Device

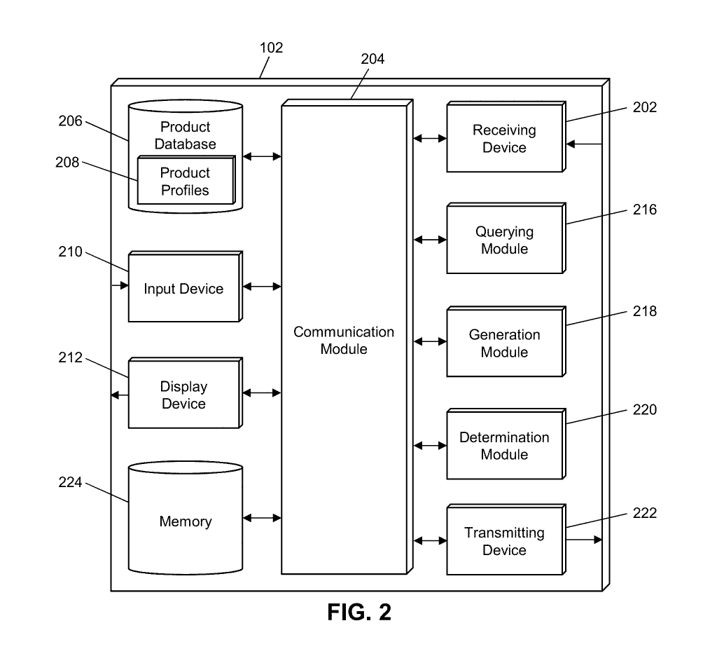

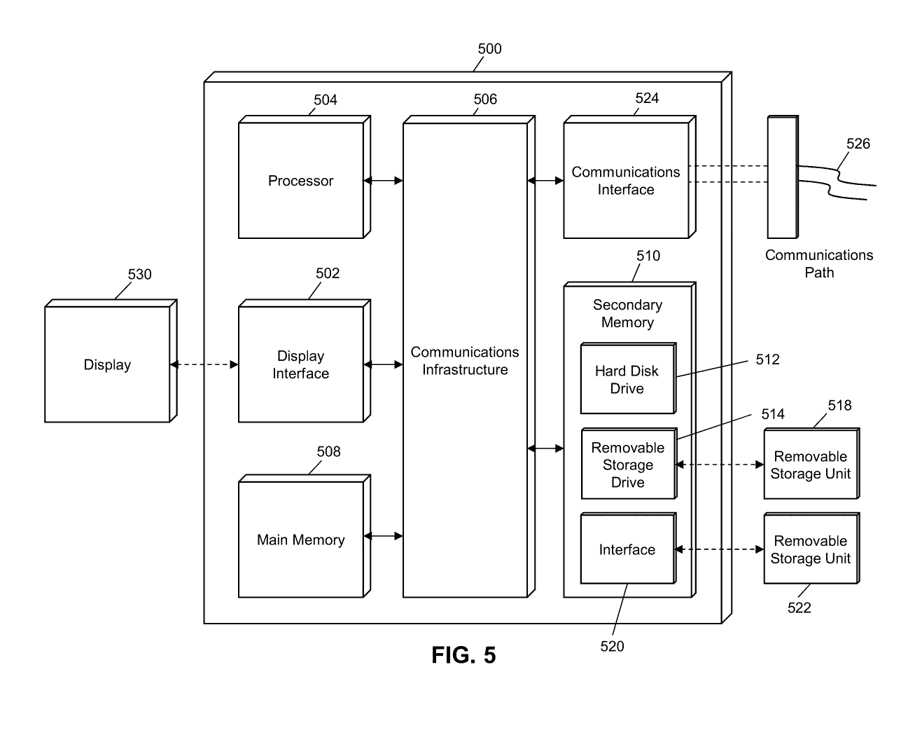

FIG. 2 illustrates an embodiment of a computing device 102 in the system 100. It will be apparent to persons having skill in the relevant art that the embodiment of the computing device 102 illustrated in FIG. 2 is provided as illustration only and may not be exhaustive to all possible configurations of the computing device 102 suitable for performing the functions as discussed herein. For example, the computer system 500 illustrated in FIG. 5 and discussed in more detail below may be a suitable configuration of the computing device 102.

The computing device 102 may include a receiving device 202. The receiving device 202 may be configured to receive data over one or more networks via one or more network protocols. In some instances, the receiving device 202 may be configured to receive data from users 104, blockchain networks 106, merchants 108, and other systems and entities via one or more communication methods, such as radio frequency, local area networks, wireless area networks, cellular communication networks, Bluetooth, the Internet, etc. In some embodiments, the receiving device 202 may be comprised of multiple devices, such as different receiving devices for receiving data over different networks, such as a first receiving device for receiving data over a local area network and a second receiving device for receiving data via the Internet. The receiving device 202 may receive electronically transmitted data signals, where data may be superimposed or otherwise encoded on the data signal and decoded, parsed, read, or otherwise obtained via receipt of the data signal by the receiving device 202. In some instances, the receiving device 202 may include a parsing module for parsing the received data signal to obtain the data superimposed thereon. For example, the receiving device 202 may include a parser program configured to receive and transform the received data signal into usable input for the functions performed by the processing device to carry out the methods and systems described herein.

The receiving device 202 may be configured to receive data signals electronically transmitted by blockchain networks 106 that are superimposed or otherwise encoded with blockchain data, such as may be used in verification of product fulfillment submissions or for use in generating new blocks (e.g., in embodiments where the computing device 102 may be a node in the blockchain network 106). The receiving device 202 may also be configured to receive data signals electronically transmitted by blockchain networks 106 and/or merchants 108, which may be superimposed or otherwise encoded with merchant bids for fulfillment. Merchant bids may include a product identifier to which the bid is associated and may include one or more bid criteria, such as price, quantity, product details, etc.

The computing device 102 may also include a communication module 204. The communication module 204 may be configured to transmit data between modules, engines, databases, memories, and other components of the computing device 102 for use in performing the functions discussed herein. The communication module 204 may be comprised of one or more communication types and utilize various communication methods for communications within a computing device. For example, the communication module 204 may be comprised of a bus, contact pin connectors, wires, etc. In some embodiments, the communication module 204 may also be configured to communicate between internal components of the computing device 102 and external components of the computing device 102, such as externally connected databases, display devices, input devices, etc. The computing device 102 may also include a processing device. The processing device may be configured to perform the functions of the computing device 102 discussed herein as will be apparent to persons having skill in the relevant art. In some embodiments, the processing device may include and/or be comprised of a plurality of engines and/or modules specially configured to perform one or more functions of the processing device, such as a querying module 216, generation module 218, determination module 220, etc. As used herein, the term “module” may be software or hardware particularly programmed to receive an input, perform one or more processes using the input, and provides an output. The input, output, and processes performed by various modules will be apparent to one skilled in the art based upon the present disclosure.

The computing device 102 may include a product database 206. The product database 206 may be configured to store a plurality of product profiles 208 using a suitable data storage format and schema. The product database 206 may be a relational database that utilizes structured query language for the storage, identification, modifying, updating, accessing, etc. of structured data sets stored therein. Each product profile 208 may be a structured data set configured to store data related to a product eligible for fulfillment. A product profile 208 may include at least a product identifier associated with the related product, a storage amount representing the current amount of the product, and a threshold level. The storage amount and threshold level may be represented using units that may vary based on the type of product and measurement method used for the product. In some instances, a product profile 208 may also include criteria used in the fulfillment of the related product, such as for fulfilling by a merchant 108 or for use by the computing device 102 when selecting merchant bids.

The computing device 102 may also include or be otherwise interfaced with one or more input devices 210. The input devices 210 may be internal to the computing device 102 or external to the computing device 102 and connected thereto via one or more connections (e.g., wired or wireless) for the transmission of data to and/or from. The input devices 210 may be configured to receive input from a user (e.g., the user 104) of the computing device 102, which may be provided to another module or engine of the computing device 102 (e.g., via the communication module 204) for processing accordingly. Input devices 210 may include any type of input device suitable for receiving input for the performing of the functions discussed herein, such as a keyboard, mouse, click wheel, scroll wheel, microphone, touch screen, track pad, camera, optical imager, etc. The input device 210 may be configured to, for example, receive input for registering products in the computing device 102 via product identifiers, setting or managing criteria and preferences for fulfillment and merchant bidding, and other interactions between the user 104 and computing device 102 as discussed herein.

The computing device 102 may also include or be otherwise interfaced with a display device 212. The display device 212 may be internal to the computing device 102 or external to the computing device 102 and connected thereto via one or more connections (e.g., wired or wireless) for the transmission of data to and/or from. The display device 212 may be configured to display data to a user (e.g., the user 104) of the computing device 102. The display device 212 may be any type of display suitable for displaying data as part of the functions discussed herein, such as a liquid crystal display, light emitting diode display, thin film transistor display, capacitive touch display, cathode ray tube display, light projection display, etc. In some instances, the computing device 102 may include multiple display devices 212. The display device 212 may be configured to, for example, display a listing of associated products, current levels for each product, current threshold levels, available merchant bids for selection by the user 104, or other data that may be beneficial for the user 104 in connection with the functions discussed herein. For instance, the display device 212 may display data for the creation and modification of criteria and other user preferences.

The computing device 102 may include a querying module 216. The querying module 216 may be configured to execute queries on databases to identify information. The querying module 216 may receive one or more data values or query strings, and may execute a query string based thereon on an indicated database, such as the profile database 206, to identify information stored therein. The querying module 216 may then output the identified information to an appropriate engine or module of the computing device 102 as necessary. The querying module 216 may, for example, execute a query on the profile database 206 to update storage amounts in product profiles 208 when level changes are detected, and to identify if a threshold level has been met for any products. The querying module 216 may also be configured to execute queries on the profile database 206 to register new products and to insert or modify existing fulfillment or bid criteria stored in the profile database 206 or other storage of the computing device 102.

The computing device 102 may also include a generation module 218. The generation module 218 may be configured to generate data for use in performing the functions of the computing device 102 as discussed herein. The generation module 218 may receive an instruction as input, may generate data as instructed, and may output the generated data to another module or engine of the computing device 102. For example, the generation module 218 may be configured to generate transaction values for product fulfillment, which may include product identifiers, device identifiers, and any criteria associated with a product to be fulfilled. In some cases, the generation module 218 may also generate transaction values to indicate product fulfillments as being closed after identification of winning bids. In embodiments where the computing device 102 may be a blockchain node, the generation module 218 may also be configured to generate block headers and new blocks for addition to the blockchain, as well as reference values and transaction values for inclusion in block headers via the application of suitable hashing algorithms to corresponding data.

The computing device 102 may include a determination module 220. The determination module 220 may be configured to make data determinations as part of the functions of the computing device 102 as discussed herein. The determination module 220 may receive instructions as input, may make a determination based on the instructions, and may output a result of the determination to another module or engine of the computing device 102. In some instances, the instructions may be accompanied by data to be used in the determination. In other instances, the determination module 220 may be configured to identify data (e.g., via issuing instructions to the querying module 216) for use in the determination. The determination module 220 may, for example, be configured to determine if the current level of a product has met or exceeded the threshold level to where fulfillment should be requested. The determination module 220 may also be configured to determine a winning merchant bid from a plurality of merchant bids, based on bid criteria included therein, which may also be compared to criteria stored in the computing device 102 and registered by the user 104.

The computing device 102 may also include a transmitting device 222. The transmitting device 222 may be configured to transmit data over one or more networks via one or more network protocols. In some instances, the transmitting device 222 may be configured to transmit data to blockchain networks 106, merchants 108, and other entities via one or more communication methods, local area networks, wireless area networks, cellular communication, Bluetooth, radio frequency, the Internet, etc. In some embodiments, the transmitting device 222 may be comprised of multiple devices, such as different transmitting devices for transmitting data over different networks, such as a first transmitting device for transmitting data over a local area network and a second transmitting device for transmitting data via the Internet. The transmitting device 222 may electronically transmit data signals that have data superimposed that may be parsed by a receiving computing device. In some instances, the transmitting device 222 may include one or more modules for superimposing, encoding, or otherwise formatting data into data signals suitable for transmission.

The transmitting device 222 may be configured to electronically transmit data signals to blockchain networks 106, which may be superimposed or otherwise encoded with transaction values and/or blocks for verification and addition to the associated blockchain. The transmitting device 222 may also be configured to electronically transmit data signals superimposed or otherwise encoded with bid data, such as including shipping or billing information, as well as winning bid information, to blockchain networks 106 and/or merchants 108.

The computing device 102 may also include a memory 224. The memory 224 may be configured to store data for use by the computing device 102 in performing the functions discussed herein, such as public and private keys, symmetric keys, etc. The memory 224 may be configured to store data using suitable data formatting methods and schema and may be any suitable type of memory, such as read-only memory, random access memory, etc. The memory 224 may include, for example, encryption keys and algorithms, communication protocols and standards, data formatting standards and protocols, program code for modules and application programs of the processing device, and other data that may be suitable for use by the computing device 102 in the performance of the functions disclosed herein as will be apparent to persons having skill in the relevant art. In some embodiments, the memory 224 may be comprised of or may otherwise include a relational database that utilizes structured query language for the storage, identification, modifying, updating, accessing, etc. of structured data sets stored therein. The memory 224 may be configured to store, for example, blockchain data and user criteria for product fulfillment and winning bid identification.

### Process for Automated Fulfillment via Blockchain

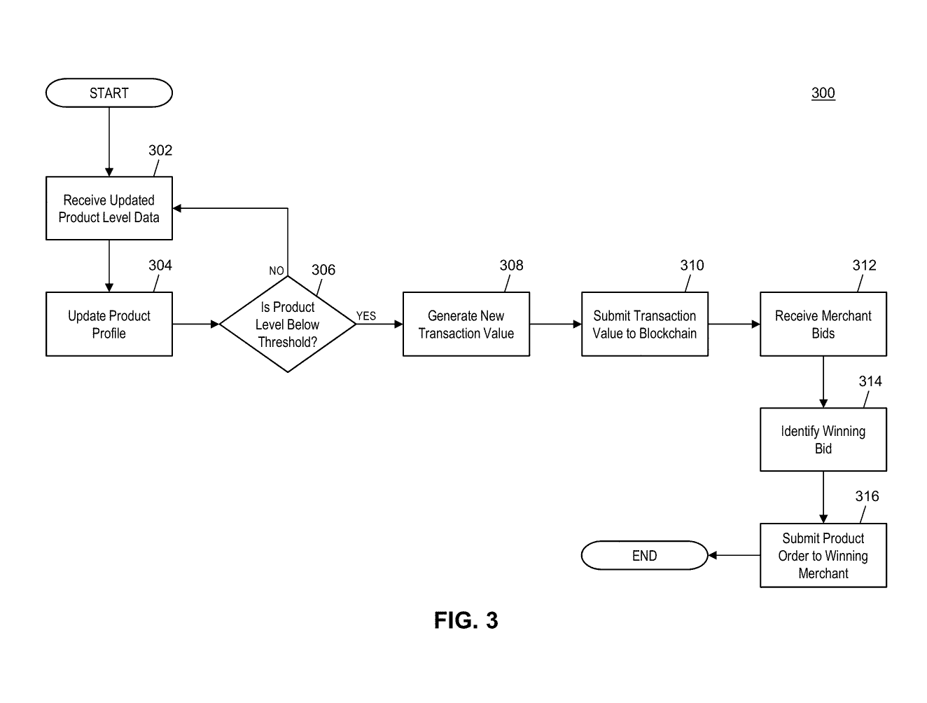

FIG. 3 illustrates a process 300 for the automated fulfillment of products via the use of a blockchain and subsequent merchant bidding as executed by the computing device 102 of the system 100.

In step 302, one or more input devices 210 of the computing device 102 may detect an updated level of one or more products associated therewith, which may be delivered to the rest of the computing device 102 via the communication module 204. In step 304, the querying module 216 of the computing device 102 may execute queries on the product database 206 of the computing device 102 to update product profiles 208 for each product where an updated level is received. In step 306, the determination module 220 of the computing device 102 may determine, for each of the updated products, if the updated product level is below the threshold level stored in the corresponding product profile 208.

If the product level is not below the threshold, then the process 300 for that product may return to step 302 where the computing device 102 may continue to monitor the level of that product and update it accordingly. Once the level of a product is determined to be below the product's threshold level, then, in step 308, the generation module 218 of the computing device 102 may generate a transaction value for fulfillment of the product. The transaction value may be formatted as required by a blockchain network 106 to which it will be posted, and may include at least the product identifier for the product and a device identifier associated with the computing device 102. The product identifier may be a unique value associated with the product, such as a universal product code, serial number, registration number, European article number, stock-keeping unit, etc. The device identifier may be a unique value associated with the computing device 102, which may also be used for communication therewith, such as a media access control address, internet protocol address, e-mail address, telephone number, registration number, serial number, device name, username, etc. In some embodiments, the transaction value may also include criteria regarding fulfillment of the product, such as product specifications, quantity, shipping information, etc.

In step 310, the transmitting device 222 of the computing device 102 may electronically transmit the generated transaction value to a node in the blockchain network 106. The node may include the transaction value in a new block that is validated and added to the blockchain. Merchants 108 may view the transaction value in the blockchain and, in step 312, the receiving device 202 of the computing device 102 may receive a plurality of merchant bids in associated therewith. Each merchant bid may include at least one or more bid properties, which may include, for example, price, product details, shipping times, shipping cost, delivery method, etc. In step 314, the determination module 220 of the computing device 102 may identify a winning bid from the plurality of merchant bids. The winning bid may be determined based on the bid properties included therein, which may be compared to criteria supplied by the user 104 (e.g., and stored in the memory 224 of the computing device 102, as identified via the querying module 216).

In step 316, the transmitting device 222 of the computing device 102 may electronically transmit a product order to the merchant 108 that submitted the winning bid. In some embodiments, the product order may be transmitted to the blockchain network 106, which may forward the product order to the winning merchant 108. In other embodiments, the bid properties may include contact information, which may be used by the computing device 102 for direct submission of the product order to the winning merchant 108. The product order may include any data necessary for the fulfillment of the product in compliance with the winning bid, such as shipping information, payment information, etc. In some embodiments, the process 300 may also include the generation and submission of a new transaction value to the blockchain network 106 that indicates that the fulfilled product is closed for bidding.

### Exemplary Method for Automated Product Fulfillment via Blockchain

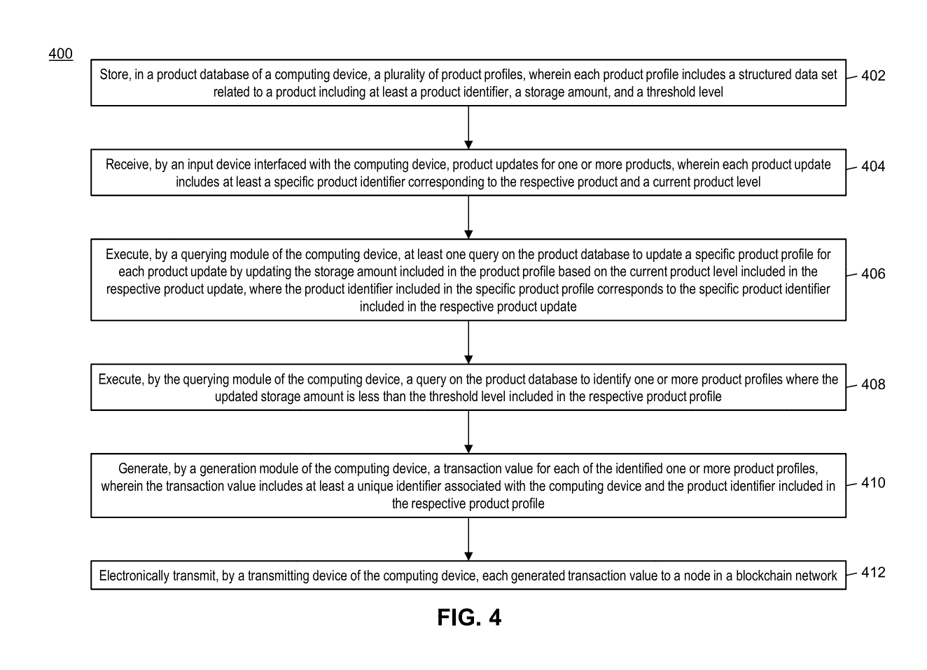

FIG. 4 illustrates a method 400 for the automated fulfillment of a product upon the reaching of a predetermined threshold level via the use of a blockchain for conveyance of product and fulfillment data.

In step 402, a plurality of product profiles (e.g., product profiles 208) may be stored in a product database (e.g., the product database 206) of a computing device (e.g., the computing device 102), wherein each product profile includes a structured data set related to a product including at least a product identifier, a storage amount, and a threshold level. In step 404, product updates may be received for one or more products by an input device (e.g., the input device 210) interfaced with the computing device, wherein each product update includes at least a specific product identifier corresponding to the respective product and a current product level.

In step 406, at least one query may be executed on the product database by a querying module (e.g., the querying module 216) of the computing device to update a specific product profile for each product update by updating the storage amount included in the product profile based on the current product level included in the respective product update, where the product identifier included in the specific product profile corresponds to the specific product identifier included in the respective product update. In step 408, a query may be executed on the product database by the querying module of the computing device to identify one or more product profiles where the updated storage amount is less than the threshold level included in the respective product profile.

In step 410, a transaction value may be generated for each of the identified one or more product profiles by a generation module (e.g., the generation module 218) of the computing device, wherein the transaction value includes at least a unique identifier associated with the computing device and the product identifier included in the respective product profile. In step 412, each generated transaction value may be electronically transmitted by a transmitting device (e.g., the transmitting device 222) of the computing device to a node in a blockchain network (e.g., the blockchain network 106).

In one embodiment, the method 400 may further include: storing, in a memory (e.g., the memory 224) of the computing device, a blockchain comprised of a plurality of blocks, wherein each block includes at least a header having a timestamp and a plurality of transaction values; generating, by the generation module of the computing device, a new block header, wherein the new block header includes at least a current timestamp, a reference hash value generated via hashing of the header included in a most recent block of the plurality of blocks as identified based on the timestamp included therein, and a transaction hash value generated via hashing each of the generated transaction values; and generating, by the generation module of the computing device, a new block comprised of at least the new block header and each of the generated transaction values, wherein the generated transaction values are electronically transmitted as part of the generated new block. In some embodiments, the computing device may be a node in the blockchain network. In one embodiment, each product profile may further include a requested amount, and each transaction value may further include the requested amount included in the respective product profile.

In some embodiments, the method 400 may also include receiving, by a receiving device (e.g., the receiving device 202) of the computing device, a plurality of merchant bids for a target product identifier included in one of the generated transaction values, wherein each merchant bid includes at least one or more bid properties; and identifying, by a determination module (e.g., the determination module 220) of the computing device, a winning merchant bid of the plurality of merchant bids based on at least the one or more bid properties included in each of the plurality of merchant bids. In a further embodiment, the plurality of product profiles may include a target product profile where the included product identifier corresponds to the target product identifier, the target product profile may further include one or more purchasing criteria, and the winning merchant bid may be identified based on a correspondence between the one or more bid properties included in each of the plurality of merchant bids and the one or more purchasing criteria. In another further embodiment, the method 400 may even further include storing, in the memory of the computing device, one or more purchasing criteria, wherein the winning merchant bid is identified based on a correspondence between the one or more bid properties included in each of the plurality of merchant bids and the one or more purchasing criteria. In yet another further embodiment, the method 400 may also include generating, by the generation module of the computing device, a new transaction value, wherein the new transaction value includes at least the target product identifier, unique identifier, and an indication of fulfillment; and electronically transmitting, by the transmitting device of the computing device, the new transaction value to the node in the blockchain network.

### Computer System Architecture

FIG. 5 illustrates a computer system 500 in which embodiments of the present disclosure, or portions thereof, may be implemented as computer-readable code. For example, the computing device 102 of FIG. 1 may be implemented in the computer system 500 using hardware, software, firmware, non-transitory computer readable media having instructions stored thereon, or a combination thereof and may be implemented in one or more computer systems or other processing systems. Hardware, software, or any combination thereof may embody modules and components used to implement the methods of FIGS. 3 and 4.

If programmable logic is used, such logic may execute on a commercially available processing platform configured by executable software code to become a specific purpose computer or a special purpose device (e.g., programmable logic array, application-specific integrated circuit, etc.). A person having ordinary skill in the art may appreciate that embodiments of the disclosed subject matter can be practiced with various computer system configurations, including multi-core multiprocessor systems, minicomputers, mainframe computers, computers linked or clustered with distributed functions, as well as pervasive or miniature computers that may be embedded into virtually any device. For instance, at least one processor device and a memory may be used to implement the above described embodiments.

A processor unit or device as discussed herein may be a single processor, a plurality of processors, or combinations thereof. Processor devices may have one or more processor “cores.” The terms “computer program medium,” “non-transitory computer readable medium,” and “computer usable medium” as discussed herein are used to generally refer to tangible media such as a removable storage unit 518, a removable storage unit 522, and a hard disk installed in hard disk drive 512.

Various embodiments of the present disclosure are described in terms of this example computer system 500. After reading this description, it will become apparent to a person skilled in the relevant art how to implement the present disclosure using other computer systems and/or computer architectures. Although operations may be described as a sequential process, some of the operations may in fact be performed in parallel, concurrently, and/or in a distributed environment, and with program code stored locally or remotely for access by single or multi-processor machines. In addition, in some embodiments the order of operations may be rearranged without departing from the spirit of the disclosed subject matter.

Processor device 504 may be a special purpose or a general purpose processor device specifically configured to perform the functions discussed herein. The processor device 504 may be connected to a communications infrastructure 506, such as a bus, message queue, network, multi-core message-passing scheme, etc. The network may be any network suitable for performing the functions as disclosed herein and may include a local area network (LAN), a wide area network (WAN), a wireless network (e.g., WiFi), a mobile communication network, a satellite network, the Internet, fiber optic, coaxial cable, infrared, radio frequency (RF), or any combination thereof. Other suitable network types and configurations will be apparent to persons having skill in the relevant art. The computer system 500 may also include a main memory 508 (e.g., random access memory, read-only memory, etc.), and may also include a secondary memory 510. The secondary memory 510 may include the hard disk drive 512 and a removable storage drive 514, such as a floppy disk drive, a magnetic tape drive, an optical disk drive, a flash memory, etc.

The removable storage drive 514 may read from and/or write to the removable storage unit 518 in a well-known manner. The removable storage unit 518 may include a removable storage media that may be read by and written to by the removable storage drive 514. For example, if the removable storage drive 514 is a floppy disk drive or universal serial bus port, the removable storage unit 518 may be a floppy disk or portable flash drive, respectively. In one embodiment, the removable storage unit 518 may be non-transitory computer readable recording media.

In some embodiments, the secondary memory 510 may include alternative means for allowing computer programs or other instructions to be loaded into the computer system 500, for example, the removable storage unit 522 and an interface 520. Examples of such means may include a program cartridge and cartridge interface (e.g., as found in video game systems), a removable memory chip (e.g., EEPROM, PROM, etc.) and associated socket, and other removable storage units 522 and interfaces 520 as will be apparent to persons having skill in the relevant art.

Data stored in the computer system 500 (e.g., in the main memory 508 and/or the secondary memory 510) may be stored on any type of suitable computer readable media, such as optical storage (e.g., a compact disc, digital versatile disc, Blu-ray disc, etc.) or magnetic tape storage (e.g., a hard disk drive). The data may be configured in any type of suitable database configuration, such as a relational database, a structured query language (SQL) database, a distributed database, an object database, etc. Suitable configurations and storage types will be apparent to persons having skill in the relevant art.

The computer system 500 may also include a communications interface 524. The communications interface 524 may be configured to allow software and data to be transferred between the computer system 500 and external devices. Exemplary communications interfaces 524 may include a modem, a network interface (e.g., an Ethernet card), a communications port, a PCMCIA slot and card, etc. Software and data transferred via the communications interface 524 may be in the form of signals, which may be electronic, electromagnetic, optical, or other signals as will be apparent to persons having skill in the relevant art. The signals may travel via a communications path 526, which may be configured to carry the signals and may be implemented using wire, cable, fiber optics, a phone line, a cellular phone link, a radio frequency link, etc.

The computer system 500 may further include a display interface 502. The display interface 502 may be configured to allow data to be transferred between the computer system 500 and external display 530. Exemplary display interfaces 502 may include high-definition multimedia interface (HDMI), digital visual interface (DVI), video graphics array (VGA), etc. The display 530 may be any suitable type of display for displaying data transmitted via the display interface 502 of the computer system 500, including a cathode ray tube (CRT) display, liquid crystal display (LCD), light-emitting diode (LED) display, capacitive touch display, thin-film transistor (TFT) display, etc.

Computer program medium and computer usable medium may refer to memories, such as the main memory 508 and secondary memory 510, which may be memory semiconductors (e.g., DRAMs, etc.). These computer program products may be means for providing software to the computer system 500. Computer programs (e.g., computer control logic) may be stored in the main memory 508 and/or the secondary memory 510. Computer programs may also be received via the communications interface 524. Such computer programs, when executed, may enable computer system 500 to implement the present methods as discussed herein. In particular, the computer programs, when executed, may enable processor device 504 to implement the methods illustrated by FIGS. 3 and 4, as discussed herein. Accordingly, such computer programs may represent controllers of the computer system 500. Where the present disclosure is implemented using software, the software may be stored in a computer program product and loaded into the computer system 500 using the removable storage drive 514, interface 520, and hard disk drive 512, or communications interface 524.

The processor device 504 may comprise one or more modules or engines configured to perform the functions of the computer system 500. Each of the modules or engines may be implemented using hardware and, in some instances, may also utilize software, such as corresponding to program code and/or programs stored in the main memory 508 or secondary memory 510. In such instances, program code may be compiled by the processor device 504 (e.g., by a compiling module or engine) prior to execution by the hardware of the computer system 500. For example, the program code may be source code written in a programming language that is translated into a lower level language, such as assembly language or machine code, for execution by the processor device 504 and/or any additional hardware components of the computer system 500. The process of compiling may include the use of lexical analysis, preprocessing, parsing, semantic analysis, syntax-directed translation, code generation, code optimization, and any other techniques that may be suitable for translation of program code into a lower level language suitable for controlling the computer system 500 to perform the functions disclosed herein. It will be apparent to persons having skill in the relevant art that such processes result in the computer system 500 being a specially configured computer system 500 uniquely programmed to perform the functions discussed above.

Techniques consistent with the present disclosure provide, among other features, systems and methods for automated product fulfillment via blockchain. While various exemplary embodiments of the disclosed system and method have been described above it should be understood that they have been presented for purposes of example only, not limitations. It is not exhaustive and does not limit the disclosure to the precise form disclosed. Modifications and variations are possible in light of the above teachings or may be acquired from practicing of the disclosure, without departing from the breadth or scope.

What is claimed is:

1. A method for automated product fulfillment via blockchain, comprising:
storing, in a product database of a computing device, a plurality of product profiles, wherein each product profile includes a structured data set related to a product including at least a product identifier, a storage amount, and a threshold level;
receiving, by an input device interfaced with the computing device, product updates for one or more products, wherein each product update includes at least a specific product identifier corresponding to the respective product and a current product level;
executing, by a querying module of the computing device, at least one query on the product database to update a specific product profile for each product update by updating the storage amount included in the product profile based on the current product level included in the respective product update, where the product identifier included in the specific product profile corresponds to the specific product identifier included in the respective product update;
executing, by the querying module of the computing device, a query on the product database to identify one or more product profiles where the updated storage amount is less than the threshold level included in the respective product profile;
generating, by a generation module of the computing device, a transaction value for each of the identified one or more product profiles, wherein the transaction value includes at least a unique identifier associated with the computing device and the product identifier included in the respective product profile; and
electronically transmitting, by a transmitting device of the computing device, each generated transaction value to a node in a blockchain network.

2. The method of claim 1, further comprising:
storing, in a memory of the computing device, a blockchain comprised of a plurality of blocks, wherein each block includes at least a header having a timestamp and a plurality of transaction values;
generating, by the generation module of the computing device, a new block header, wherein the new block header includes at least a current timestamp, a reference hash value generated via hashing of the header included in a most recent block of the plurality of blocks as identified based on the timestamp included therein, and a transaction hash value generated via hashing each of the generated transaction values; and
generating, by the generation module of the computing device, a new block comprised of at least the new block header and each of the generated transaction values, wherein
the generated transaction values are electronically transmitted as part of the generated new block.

3. The method of claim 1, wherein the computing device is a node in the blockchain network.

4. The method of claim 1, wherein
each product profile further includes a requested amount, and
each transaction value further includes the requested amount included in the respective product profile.

5. The method of claim 1, further comprising:
receiving, by a receiving device of the computing device, a plurality of merchant bids for a target product identifier included in one of the generated transaction values, wherein each merchant bid includes at least one or more bid properties; and
identifying, by a determination module of the computing device, a winning merchant bid of the plurality of merchant bids based on at least the one or more bid properties included in each of the plurality of merchant bids.

6. The method of claim 5, wherein
the plurality of product profiles includes a target product profile where the included product identifier corresponds to the target product identifier,
the target product profile further includes one or more purchasing criteria, and
the winning merchant bid is identified based on a correspondence between the one or more bid properties included in each of the plurality of merchant bids and the one or more purchasing criteria.

7. The method of claim 5, further comprising:
storing, in a memory of the computing device, one or more purchasing criteria, wherein
the winning merchant bid is identified based on a correspondence between the one or more bid properties included in each of the plurality of merchant bids and the one or more purchasing criteria.

8. The method of claim 5, further comprising:
generating, by the generation module of the computing device, a new transaction value, wherein the new transaction value includes at least the target product identifier, unique identifier, and an indication of fulfillment; and
electronically transmitting, by the transmitting device of the computing device, the new transaction value to the node in the blockchain network.

9. A system for automated product fulfillment via blockchain, comprising:
a product database of a computing device configured to store a plurality of product profiles, wherein each product profile includes a structured data set related to a product including at least a product identifier, a storage amount, and a threshold level;
an input device interfaced with the computing device configured to receive product updates for one or more products, wherein each product update includes at least a specific product identifier corresponding to the respective product and a current product level;
a querying module of the computing device configured to execute
at least one query on the product database to update a specific product profile for each product update by updating the storage amount included in the product profile based on the current product level included in the respective product update, where the product identifier included in the specific product profile corresponds to the specific product identifier included in the respective product update, and
a query on the product database to identify one or more product profiles where the updated storage amount is less than the threshold level included in the respective product profile;
a generation module of the computing device configured to generate a transaction value for each of the identified one or more product profiles, wherein the transaction value includes at least a unique identifier associated with the computing device and the product identifier included in the respective product profile; and
a transmitting device of the computing device configured to electronically transmit each generated transaction value to a node in a blockchain network.

10. The system of claim 9, further comprising:
a memory of the computing device configured to store a blockchain comprised of a plurality of blocks, wherein each block includes at least a header having a timestamp and a plurality of transaction values, wherein
the generation module of the computing device is further configured to
generate a new block header, wherein the new block header includes at least a current timestamp, a reference hash value generated via hashing of the header included in a most recent block of the plurality of blocks as identified based on the timestamp included therein, and a transaction hash value generated via hashing each of the generated transaction value, and
generate a new block comprised of at least the new block header and each of the generated transaction values, and
the generated transaction values are electronically transmitted as part of the generated new block.

11. The system of claim 9, wherein the computing device is a node in the blockchain network.

12. The system of claim 9, wherein
each product profile further includes a requested amount, and
each transaction value further includes the requested amount included in the respective product profile.

13. The system of claim 9, further comprising:
a receiving device of the computing device configured to receive a plurality of merchant bids for a target product identifier included in one of the generated transaction values, wherein each merchant bid includes at least one or more bid properties; and
a determination module of the computing device configured to identify a winning merchant bid of the plurality of merchant bids based on at least the one or more bid properties included in each of the plurality of merchant bids.

14. The system of claim 13, wherein
the plurality of product profiles includes a target product profile where the included product identifier corresponds to the target product identifier,
the target product profile further includes one or more purchasing criteria, and
the winning merchant bid is identified based on a correspondence between the one or more bid properties included in each of the plurality of merchant bids and the one or more purchasing criteria.

15. The system of claim 13, further comprising:
a memory of the computing device configured to store one or more purchasing criteria, wherein
the winning merchant bid is identified based on a correspondence between the one or more bid properties included in each of the plurality of merchant bids and the one or more purchasing criteria.

16. The system of claim 13, wherein
the generation module of the computing device is further configured to generate a new transaction value, wherein the new transaction value includes at least the target product identifier, unique identifier, and an indication of fulfillment, and
the transmitting device of the computing device is further configured to electronically transmit the new transaction value to the node in the blockchain network.
